(19) United States
(12) Patent Application Publication
(10) Pub. No.: US 2019/0176308 A1
(43) Pub. Date: Jun. 13, 2019

(54) PORTABLE CRIMPING TOOL FOR FLEXIBLE PIPING

(71) Applicant: FLEX PIPING SOLUTIONS, LLC, Cincinnati, OH (US)

(72) Inventor: Brian Swift, Cincinnati, OH (US)

(21) Appl. No.: 16/213,408

(22) Filed: Dec. 7, 2018

Related U.S. Application Data
(60) Provisional application No. 62/595,772, filed on Dec. 7, 2017.

(51) Int. Cl. B25B 27/10

(52) U.S. Cl. CPC B25B 27/10

(57) ABSTRACT

A pipe fitting crimping tool includes a ring-shaped hub member, a plurality of crimping dies, and ring-shaped hub guide. The hub member and the hub guide are moveable relative to one another to cause expansion and contraction of the crimping dies. Additionally, the hub member and the hub guide are both openable such that the pipe and the pipe fitting may be placed in a central aperture without completely disassembling the tool A method of making a joined pipe and pipe fitting includes inserting at least a portion of the pipe fitting into an end of the pipe, contacting the end of the pipe including the pipe fitting with a tool, activating the actuator to cause a decrease in an inner diameter of the central aperture thus providing the joined pipe and pipe fitting, and removing the tool from the joined pipe and pipe fitting.

### CROSS-REFERENCE TO RELATED APPLICATION

This application claims the benefit of U.S. Provisional Application No. 62/595,772, filed Dec. 7, 2017, the entire contents of which are incorporated herein by reference.

### TECHNICAL FIELD

This application relates generally to crimping tools for affixing fittings to pipes and, more particularly, to a portable crimping tool that is well suited for use in the field.

### BACKGROUND

Typical crimping tools for affixing fittings to pipes are large, complex, and must be used in a shop environment. Also, adapting typical crimping tools to accommodate a large variety of pipe diameters is quite difficult because most require complex disassembling steps to do so.

Thus, it would be desirable to provide a simple crimping apparatus adapted to the needs of use in the field.

### SUMMARY

In one aspect, a pipe fitting crimping tool, includes a ring-shaped die retaining housing and a plurality of crimping dies. The ring-shaped die retaining housing defines a plurality of internal die slots extending radially toward a central axis of the ring-shaped die retaining housing. The central axis passes through a central pipe receiving passage. The die retaining housing includes a first ring portion mated to a second ring portion to permit relative rotation between the first ring portion and the second ring portion. Each of the plurality of crimping dies is located within a respective one of the die slots and has a radially inner side with a concave curvature. Also, each crimping die is radially movable along its die slot. Relative rotation between the first ring portion and the second ring portion in a first relative direction causes the crimping dies to move radially inward toward the central axis for carrying out a crimping operation. Additionally, the die retaining housing, including the first ring portion and the second ring portion, includes at least first and second partial ring sections that are connected together to permit movement between a closed position that completes the ring-shape and an open position that breaks the ring-shape to provide access to the central pipe receiving passage.

In another aspect, a pipe fitting crimping tool includes a ring-shaped hub member, a plurality of crimping dies, and a ring-shaped hub guide. The ring-shaped hub member has first and second portions spaced apart by a plurality of standoffs. The first and second plate portions and the standoffs together at least partially define a plurality of radially extending die slots extending toward a central axis of the ring-shaped hub member about which the ring-shaped hub member defines a central pipe receiving passage. Each crimping die is located within a respective one of the die slots and has a radially inner side with a concave curvature and a radially outer side with a convex curvature. Additionally, each crimping die is radially movable along its die slot during a crimping operation. The ring-shaped hub guide is at least partially disposed between the first and second plate portions radially outward of the standoffs and includes a radially inner side with a plurality of die contact surface regions at least partially shaped to provide a variable distance between the die contact surface region and the central axis. The hub member and the hub guide are rotatable relative to each other, and the radially outer side of each crimping die rides along a respective one of the die contact surface regions during such relative rotation to cause the die member to move radially during such relative rotation. The hub member is formed into a first hub member partial ring section and a second hub member partial ring section. The hub guide is formed into a first hub guide partial ring section and a second hub guide partial ring section, and the first hub guide partial ring section is pivotally connected to the second hub guide partial ring section for movement between a closed position and an open position.

In another aspect, a method of making a joined pipe and pipe fitting includes inserting at least a portion of the pipe fitting into an end of the pipe, contacting the end of the pipe including the pipe fitting with a tool, activating the actuator to cause a decrease in an inner diameter of the central aperture thus providing the joined pipe and pipe fitting, and removing the tool from the joined pipe and pipe fitting. The tool includes an actuator and a hub having a substantially toroidal shape with a central aperture. The hub is openable such that the pipe and the pipe fitting may be placed in the central aperture without completely disassembling the tool.

In yet another aspect, A pipe fitting crimping tool includes a ring-shaped hub member, a plurality of crimping dies, and a ring-shaped hub guide. The ring-shaped hub member includes a first hub plate portion, a second hub plate portion spaced laterally apart from the first hub plate portion and a plurality of standoffs interconnecting the first hub plate portion and the second hub plate portion. The first and second hub plate portions and the standoffs together at least partially define a plurality of radially extending die slots extending toward a central axis of the ring-shaped hub member. Each crimping die is located within a respective one of the die slots and has a radially inner side with a concave curvature and a radially outer side with a convex curvature. Each crimping die is radially movable along its die slot during a crimping operation. The ring-shaped hub guide is disposed between the first hub plate portion and the second hub plate portion radially outward of the projections. The hub guide includes a radially inner side with a plurality of die contact surface regions, each die contact surface region at least partially shaped to provide a variable distance between the die contact surface region and the central axis. The hub member and the hub guide are rotatable relative to each other, and the radially outer side of each crimping die rides along a respective one of the die contact surface regions during such relative rotation to cause the die member to move radially during such relative rotation. The first hub plate portion includes a first hub part and a second hub part, the second hub plate portion includes a third hub part and a fourth hub part, and the hub guide includes a first hub guide part and a second hub guide part. The first hub part, the third hub part, and the first hub guide part are configured to be jointly pivotable about a pivot axis, and the second hub part, the fourth hub part, and the second hub guide part are configured to be pivotable about the pivot axis. The first hub part, the third hub part, and the first hub guide part include a first connection region, and the second hub part, the fourth hub part, and the second hub guide part include a second connection region. The first connection region is releasably connectable to the second connection region, and upon release, the ring-shaped hub member and the ring-shaped hub guide open to provide access to an axial through-passage formed by the ring-shaped hub member and the ring-shaped hub guide.

The details of one or more embodiments are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention. In the drawings, like reference numerals are used to indicate like features in the various views.

FIG. 1 is a diagrammatic view of a crimping tool in accordance with an embodiment of the invention.

FIG. 2 is a diagrammatic view of a hub member in accordance with an embodiment of the invention.

FIG. 3 is an exploded view of the hub member of FIG. 2.

FIG. 4 is a detail view of die and die insert in accordance with an embodiment of the invention.

FIG. 5 is a diagrammatic view of a crimping tool in accordance with an embodiment of the invention in a pre-crimp, closed configuration.

FIG. 6 is a diagrammatic view of the crimping tool of FIG. 5 in a fully-crimped, closed configuration.

FIG. 7 is a diagrammatic view of the crimping tool of FIG. 5 in a pre-crimp, open configuration.

### DETAILED DESCRIPTION

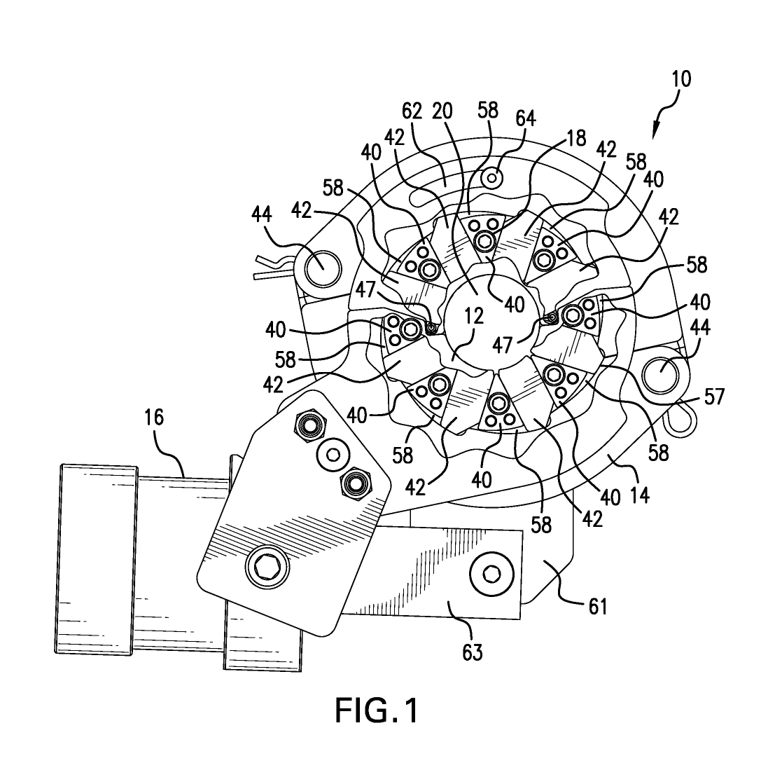

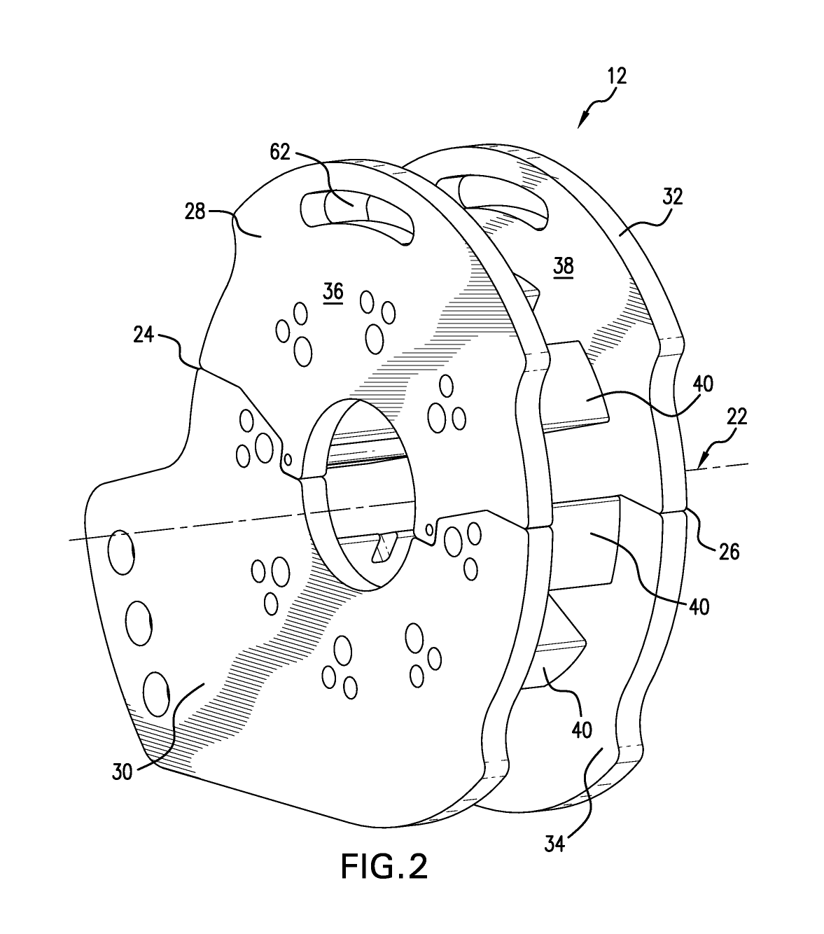

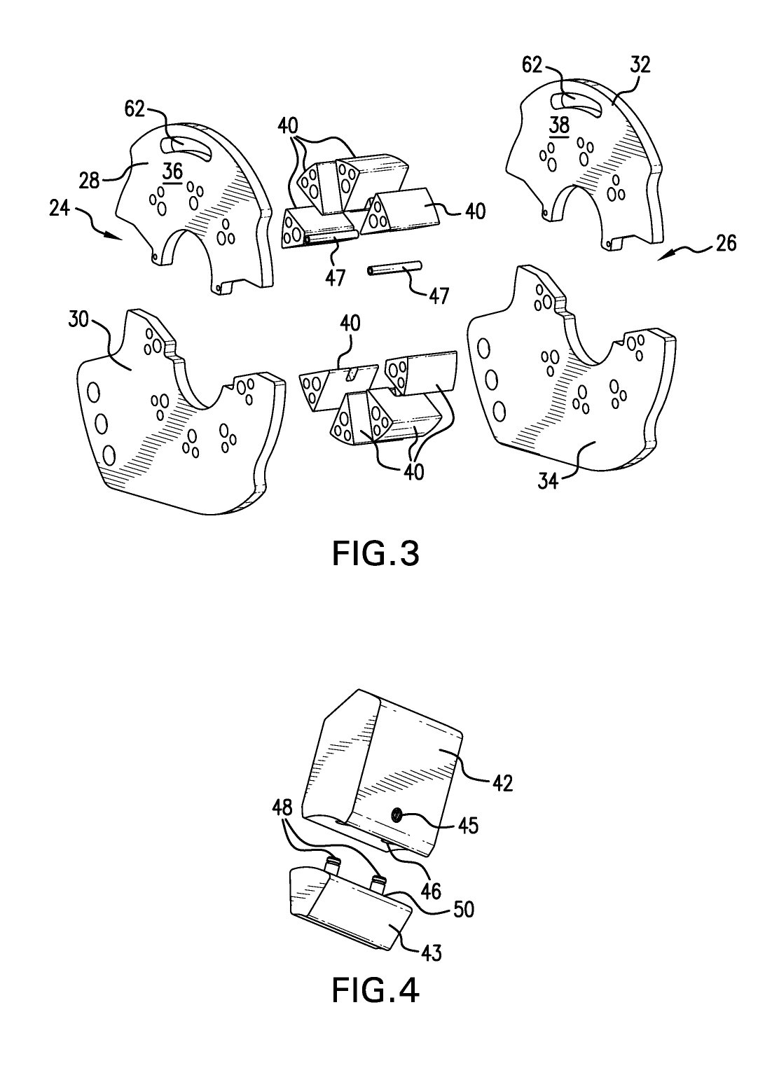

Referring to FIGS. 1-7, in one embodiment, the crimping tool 10 may include a hub member 12, a hub guide 14, and an actuator attachment assembly 16. The hub member 12 may have a substantially toroidal shape, meaning the hub member 12 may include a mostly solid portion 18 situated about a central aperture 20 through which extends an imaginary central toroidal axis 22. The hub member 12 may be multi-layered, for instance having both a first hub plate portion 24 and a second hub plate portion 26, as best shown in FIG. 2. This toroidal hub member 12 may be broken into four components, best shown in FIG. 3: a first hub part 28, a second hub part 30, a third hub part 32, and a fourth hub part 34. This arrangement may, therefore, include four components for the hub member 12. Such an arrangement solves the problem of transferring torque between portions of the hub member 12 while still allowing each portion to remain connected to the other portion of the tool to speed up tool emplacement.

The first and second hub plate portions 24, 26 may each include an outward facing side 36 and an inward facing side 38. The inward facing side 38 of each component may include a plurality of projections, which act as standoffs 40. The standoffs 40 of one of the first and second hub plate portions 24, 26 may extend toward and mate with the standoffs 40 of the other of the first and second hub plate portions 24, 26 to establish a spacing between the first and second hub plate portions 24, 26. Two adjacent standoffs 40 define a die slot for holding the crimping dies 42, which are described in more detail below. In an alternative embodiment, one of the first and second hub plate portions 24, 26 may include a plurality of standoffs 40, while the other of the first and second hub plate portions 24, 26 does not include such standoffs 40. In a further alternative embodiment, the standoffs may be formed as a separate component with end pins that fit into holes in the first and second plate portions to properly position the standoffs prior to assembly using the fasteners 47.

In use, the hub member 12 components may be joined to one another using fasteners 47, such as pins and/or bolts as shown in FIG. 1 or by other known methods of moveably connecting multiple components. For instance, possible alternative fasteners 47 include hinges, among other fasteners. One possible alternative set of fasteners 47 is self-locking pins. Such self-locking pins would increase efficiency for the user. As an alternative embodiment, fasteners 47 may not be present, with the first and third hub parts 28, 32 being joined to first hub guide part 52 and the second and fourth hub parts 30, 344 being joined to second hub guide part 54, for instance by shoulder screw 64.

A plurality of crimping dies 42 are added to the hub member 12. Conveniently, the crimping tool 10 may be configured to accommodate a large diameter pipe without any modification. However, as best shown in FIG. 4, die inserts 43 may be added to the tool 10 to be used with smaller diameter pipes. For instance, Flex Piping Solutions, LLC, sells seven sizes of Super Flex Pipe. The crimping tool 10 is originally sized for the largest diameter flex pipe, i.e., 1⅛ inch diameter flex pipe, and the remaining six sizes may be crimped using die inserts 43 placed in the tool.

The dies 42 and/or die inserts 43 may include means for removeably attaching the die inserts 43 to the tool 10 and/or the dies 42. For instance, the permanently attached dies 42 configured for the largest diameter pipe may include one or more recesses 46 to accept one or more complementary pins 48 on the die inserts 43 used for crimping smaller diameter pipes. Near the pins 48, magnets 50 may be placed to help prevent the die inserts 43 from separating from the dies 42 and the tool 10 when preparing the tool 10 for use. Magnet 50 may, for instance, be composed of a magnetic tape. Other means of removeably attaching the die inserts 43 are within the level of ordinary skill in the art.

The dies 42 may be biased radially outward away from central axis 22. Mechanisms for achieving such outward bias include, but are not limited to, springs 45.

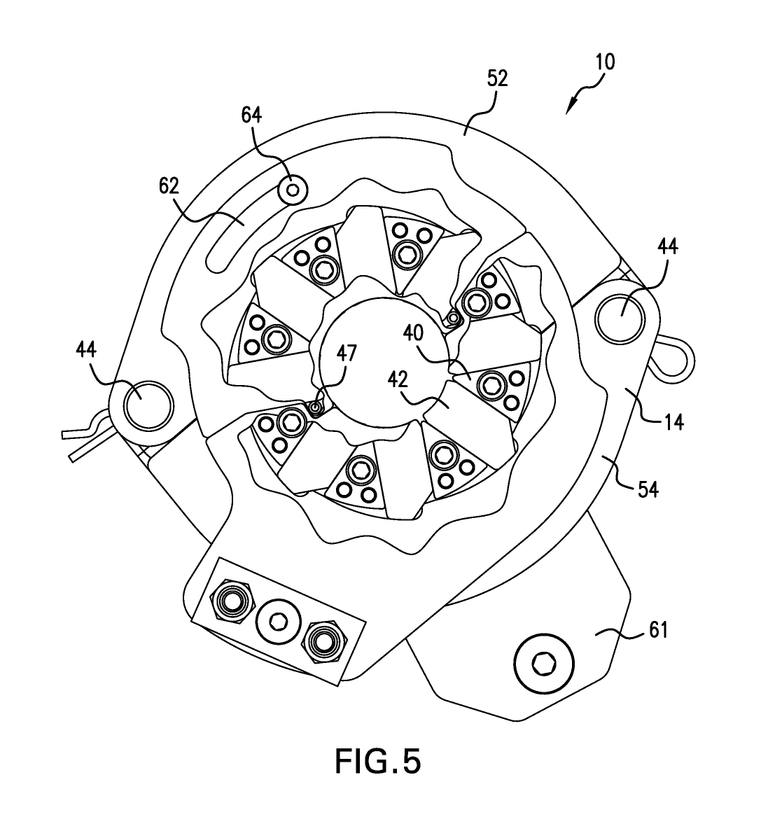

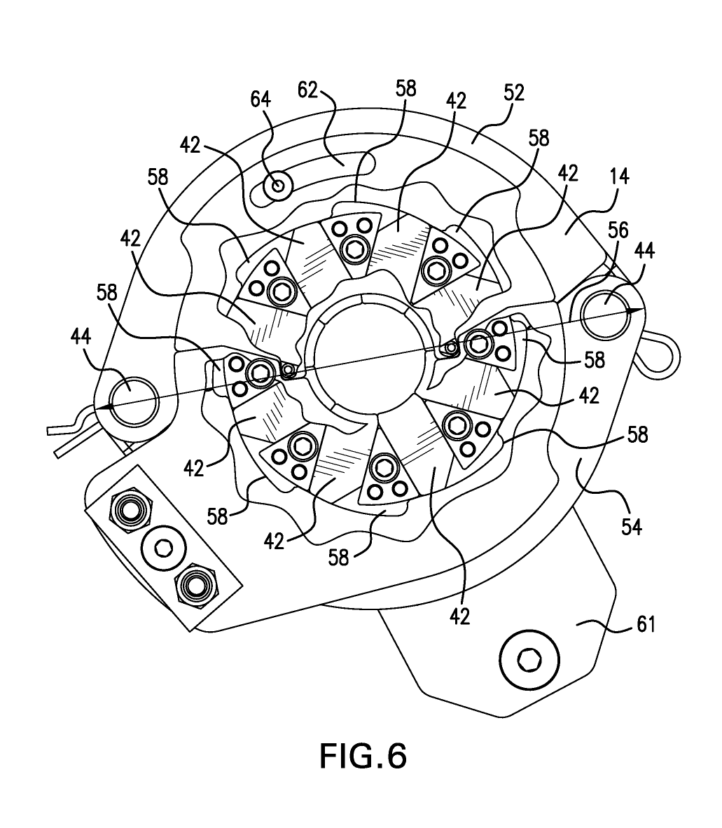

The hub guide 14 may encircle the hub member 12, as best shown in FIG. 1, and the hub guide 14 may be conveniently broken into a first hub guide part 52 and a second hub guide part 54 along a diameter 56 of the toroidal shape of the hub guide 14. The inner surface 57 of the hub guide 14 may include a plurality of trenches 58 (also called “die contact surface regions”) that are configured to push each die 42 toward the central toroidal axis 22. For example a trench 58 may have varying depth along its length such that the die 42 associated with that trench 58 is fully retracted in the non-rotated (or pre-crimp) state (see FIG. 5) and fully extended in the fully rotated (or fully crimped) state (see FIG. 6). In one embodiment, each trench 58 may have a curvature other than arcuate so as to provide a variable distance between the trench 58 and the central toroidal axis 22.

The actuator attachment assembly 16 may serve the dual purposes of providing a location for connecting the appropriate actuator to the crimping tool 10 and providing a location for rotating the hub member 12 relative to the hub guide 14 to perform the crimping operation described below. The appropriate shape and configuration of the actuator attachment assembly 16 may be determined based on the type of actuator used, the size of the actuator, the amount of torque desired for the crimping operation, and other parameters within the level of ordinary skill in the art.

The choice of actuator is not particularly limited. In one embodiment, the actuator is a hydraulic pump, either manually activated or electronically activated. For instance, the actuator may be a battery-powered hydraulic pump.

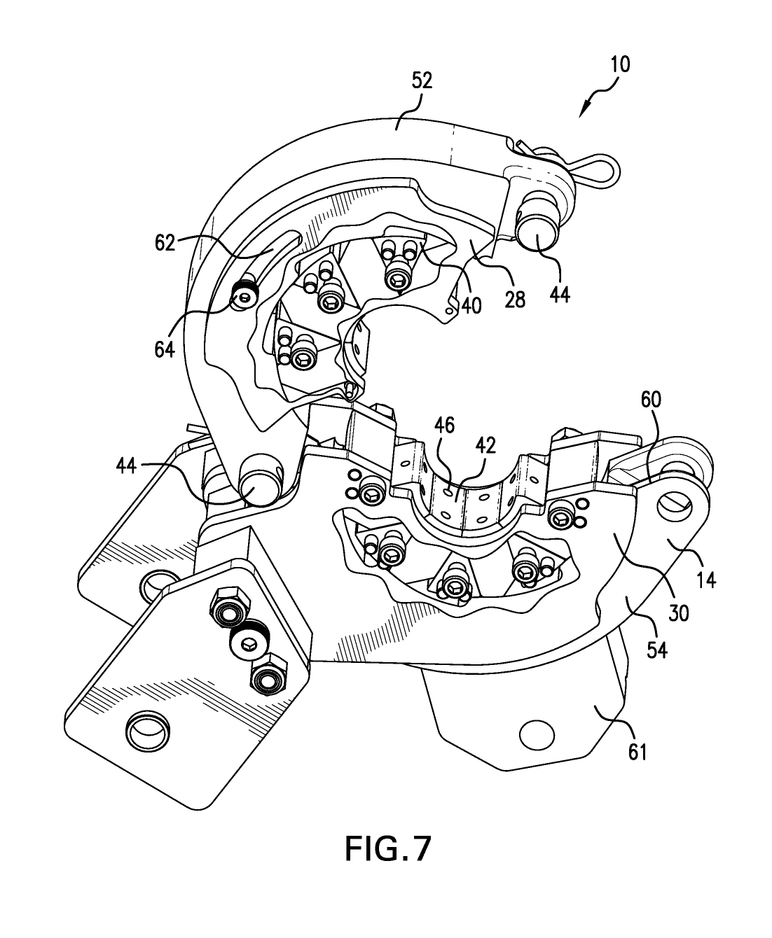

The crimping tool 10 has the ability to open and close. The closed position is best shown in FIG. 5, and the open position is shown in FIG. 7. This feature allows the user to fully assemble and disassemble the crimping tool 10 for cleaning, inspection, transport, and storage, among other advantages. This feature also allows the user to make repairs in the field. In an exemplary embodiment, connectors 44 are used in conjunction with one or more hinges 60 to connect the first and second hub guide parts 52, 54. A connector 44 passing through the first hub guide part 52 and the second hub guide part 54 of the hub guide 14 may act as the fulcrum of the hinge 60 connecting the first hub guide part 52 and the second hub guide part 54 of the hub guide 14. In addition, the hub member 12 may be configured such that the first hub part 28 and third hub part 32 separate from the second hub part 30 and fourth hub part 34 in an arrangement similar to the opening and closing of a clam shell. In this manner, the upper portions 28, 32 of the hub member 12 may remain in contact with the first hub guide part 52 of the hub guide 14 while the lower portions 30, 34 of the hub member 12 may remain in contact with the second hub guide part 54 of the hub guide 14, which allows for opening of the crimping tool 10. This ability to open and close allows the crimping tool 10 quickly to be configured for various pipe diameters and facilitates transport and use in the field.

In some embodiments, all or some of first hub part 28, second hub part 30, third hub part 32, and fourth hub part 34 of the hub member 12 may include a track 62, and the hub guide 14 may include a complementary shoulder screw 64 passing through the tracks 62. Conveniently, the upper portions 28, 32 of the hub member 12 and the first hub guide part 52 of the hub guide 14 may be connected through one set of tracks 62 and shoulder screw 64, and the lower portions 30, 34 of the hub member 12 and the second hub guide part 54 of the hub guide 14 may be connected through another set of tracks 62 and shoulder screws 64. Thus, when opening the crimping tool 10, the upper portions and lower portions stay together, and there is no need to align the six components, i.e. four components of the hub member 12 and two components of the hub guide 14, each time the crimping tool 10 is opened.

The crimping tool 10 may operate as follows. The crimping tool 10 is opened and then closed around the pipe and fitting, as described above and as best shown in FIG. 7. When the actuator is activated, the actuator applies pressure at the actuator attachment assembly 16 through moveable pressing rod 63. This, in turn, applies a linear force on fixed arm 61, which linear force is then transformed into a rotational force such that one face of the hub member 12, i.e., either the first hub part 28 and second hub part 30 or the third hub part 32 and the fourth hub part 34, is rotated about the central toroidal axis 22. The standoffs 40 of the moving face of the hub member 12 also rotate the crimping dies 42 about the central toroidal axis 22. Each die 42 may move along the plurality of trenches 58 included on the inward facing side 38 of the hub guide 14 to push the die 42 toward the central toroidal axis 22. Once the dies 42 are extended, the fitting and pipe are then joined. The hub member 12 and hub guide 14 can then be opened, as explained above, to remove the crimping tool 10 from the joined fitting and pipe.

References herein to terms such as “vertical,” “horizontal,” etc. are made by way of example, and not by way of limitation, to establish a frame of reference. It is understood that various other frames of reference may be employed for describing the invention without departing from the spirit and scope of the invention. It is also understood that features of the invention are not necessarily shown to scale in the drawings. Furthermore, to the extent that the terms “composed of,” “includes,” “having,” “has,” “with,” or variants thereof are used in either the detailed description or the claims, such terms are intended to be inclusive and open-ended in a manner similar to the term “comprising.”

References herein to terms modified by language of approximation, such as “about”, “approximately”, and “substantially”, are not to be limited to the precise value specified. The language of approximation may correspond to the precision of an instrument used to measure the value and, unless otherwise dependent on the precision of the instrument, may indicate +/−10% of the stated value(s).

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A pipe fitting crimping tool, comprising:
a ring-shaped die retaining housing defining a plurality of internal die slots extending radially toward a central axis of the ring-shaped die retaining housing, the central axis passing through a central pipe receiving passage, the die retaining housing including a first ring portion mated to a second ring portion to permit relative rotation between the first ring portion and the second ring portion;
a plurality of crimping dies, each crimping die located within a respective one of the die slots and having a radially inner side with a concave curvature, each crimping die radially movable along its die slot;
wherein relative rotation between the first ring portion and the second ring portion in a first relative direction causes the crimping dies to move radially inward toward the central axis for carrying out a crimping operation;
wherein the die retaining housing, including the first ring portion and the second ring portion, includes at least first and second partial ring sections that are connected together to permit movement between a closed position that completes the ring-shape and an open position that breaks the ring-shape to provide access to the central pipe receiving passage.

2. The tool of claim 1, wherein the first ring portion is formed by a hub member with spaced apart plate portions between which standoffs extend to define the die slots, wherein the second ring portion is formed by a hub guide at least partially disposed between the first plate portion and the second plate portion radially outward of the standoffs.

3. The tool of claim 2, wherein the hub guide includes a radially inner side with a plurality of die contact surface regions at least partially shaped to provide a variable distance between the die contact surface region and the central axis.

4. The tool of claim 3, wherein the radially outer side of each crimping die rides along a respective one of the die contact surface regions during relative rotational movement between the hub member and the hub guide.

5. The pipe fitting crimping tool of claim 1 further comprising an actuator to drive the relative rotation.

6. The pipe fitting crimping tool of claim 5 wherein the actuator comprises a hydraulic pump.

7. The pipe fitting crimping tool of claim 6 wherein the hydraulic pump is configured to be manually activated.

8. The pipe fitting crimping tool of claim 6 wherein the hydraulic pump is configured to be electronically activated.

9. The pipe fitting crimping tool of claim 1 wherein each of the crimping dies includes a die insert.

10. A pipe fitting crimping tool, comprising:
a ring-shaped hub member including first and second plate portions spaced apart by a plurality of standoffs, the first and second plate portions and the standoffs together at least partially defining a plurality of radially extending die slots extending toward a central axis of the ring-shaped hub member about which the ring-shaped hub member defines a central pipe receiving passage;
a plurality of crimping dies, each crimping die located within a respective one of the die slots and having a radially inner side with a concave curvature and a radially outer side with a convex curvature, each crimping die radially movable along its die slot during a crimping operation;
a ring-shaped hub guide at least partially disposed between the first plate portion and the second plate portion radially outward of the standoffs, the hub guide including a radially inner side with a plurality of die contact surface regions at least partially shaped to provide a variable distance between the die contact surface region and the central axis;
wherein the hub member and the hub guide are rotatable relative to each other, wherein the radially outer side of each crimping die rides along a respective one of the die contact surface regions during such relative rotation to cause the die member to move radially during such relative rotation;
wherein the hub member is formed into a first hub member partial ring section and a second hub member partial ring section;
wherein the hub guide is formed into a first hub guide partial ring section and a second hub guide partial ring section, and the first hub guide partial ring section is pivotally connected to the second hub guide partial ring section for movement between a closed position and an open position;
wherein the first hub member partial ring section is connected for pivotal movement with the first hub guide partial ring section and the second hub member partial ring section is connected for pivotal movement with the second hub guide partial ring section, such that in the open position of the hub guide the first hub member ring section and the second hub member ring section pivot open to provide access to the central pipe receiving passage.

11. The pipe fitting crimping tool of claim 10 further comprising an actuator to drive the relative rotation.

12. The pipe fitting crimping tool of claim 11 wherein the actuator comprises a hydraulic pump.

13. The pipe fitting crimping tool of claim 12 wherein the hydraulic pump is configured to be manually activated.

14. The pipe fitting crimping tool of claim 12 wherein the hydraulic pump is configured to be electronically activated.

15. The pipe fitting crimping tool of claim 10 wherein each of the crimping dies includes a die insert.

16. A method of making a joined pipe and pipe fitting, the method comprising:
inserting at least a portion of the pipe fitting into an end of the pipe;
contacting the end of the pipe including the at least a portion of the pipe fitting with a tool, wherein the tool comprises an actuator and a hub having a substantially toroidal shape with a central aperture, the hub openable such that the pipe and the pipe fitting may be placed in the central aperture without completely disassembling the tool;
activating the actuator to cause a decrease in an inner diameter of the central aperture thus providing the joined pipe and pipe fitting; and
removing the tool from the joined pipe and pipe fitting.

17. The method of claim 16 wherein the activating is performed manually.

18. The method of claim 16 wherein the activating is performed electronically.
